(19) United States
(12) Patent Application Publication
(10) Pub. No.: US 2013/0135592 A1
(43) Pub. Date: May 30, 2013

(54) LIGHT SOURCE APPARATUS AND PROJECTION DISPLAY APPARATUS

(71) Applicant: SANYO ELECTRIC CO., LTD., Osaka (JP)

(72) Inventor: Michihiro OKUDA, Osaka (JP)

(73) Assignee: SANYO ELECTRIC CO., LTD., Osaka (JP)

(21) Appl. No.: 13/688,777

(22) Filed: Nov. 29, 2012

(30) Foreign Application Priority Data
Nov. 30, 2011 (JP) 2011-263058

(51) Int. Cl. F21V 13/00; G03B 21/14

(52) U.S. Cl. CPC F21V 13/00; G03B 21/14
USPC 353/31; 362/231

(57) ABSTRACT

A light source apparatus, which includes a light source unit that emits exciting light, a light emitting body that emits reference image light in response to the exciting light, and a light collecting member that collects the exciting light on the light emitting body, comprising: an adjustment configuration that adjusts an intensity distribution of the exciting light so that intensity centers of the exciting light are provided on the light emitting body as a plurality of points.

### CROSS REFERENCE TO RELATED APPLICATIONS

This application is based upon and claims the benefit of priority from prior Japanese Patent Application No. 2011-263058, filed on Nov. 30, 2011; the entire contents of which are incorporated herein by reference.

### BACKGROUND OF THE INVENTION

1. Field of the Invention

The present invention relates to a light source apparatus provided with a light emitting body configured to emit reference image light in response to exciting light, and relates also to a projection display apparatus.

2. Description of the Related Art

Conventionally, there is known a projection display apparatus provided with a light source, an imager configured to modulate light emitted from the light source, and a projection unit configured to project light emitted from the imager onto a projection surface.

Furthermore, there is proposed a projection display apparatus provided with a light emitting body configured to emit reference image light such as red component light, green component light, and blue component light by using the light emitted from the light source as exciting light (for example, Japanese Unexamined Patent Application Publication No. 2010-85740). Specifically, a plurality of types of light emitting bodies configured to emit each color component light are provided in a color wheel, and each color component light is emitted in a time division manner by the rotation of the color wheel.

However, in the aforementioned technology, since the exciting light is collected on the light emitting body as spot light, the light emission efficiency and reliability of the light emitting body are reduced.

### SUMMARY OF THE INVENTION

A light source apparatus according to a first feature includes a light source unit (light source unit 10B) that emits exciting light, a light emitting body (light emitting body G) that emits reference image light in response to the exciting light, and a light collecting member (lenses 112 to 113) that collects the exciting light on the light emitting body. The light source apparatus comprises: an adjustment configuration that adjusts an intensity distribution of the exciting light so that intensity centers of the exciting light are provided on the light emitting body as a plurality of points.

In the first feature, the light source apparatus comprises: a rod integrator (rod integrator 30) that uniformizes the reference image light emitted from the light emitting body. The adjustment configuration adjusts the intensity distribution of the exciting light according to a shape of a light incident surface of the rod integrator.

In the first feature, the light source unit includes a plurality of light source units (light source units 10₁₁, 10₁₂, 10₂₁, 10₂₂) and a plurality of mirrors (reflection mirrors 131₁₁, 131₂₁, and polarization mirrors 132₁₂, 132₂₂) that reflects the exciting light emitted from the plurality of light source units. The plurality of mirrors include a mirror arranged to be inclined from a reference angle. The adjustment configuration is formed of the plurality of mirrors.

In the first feature, the light source unit includes a plurality of light source units and a plurality of mirrors that reflects the exciting light emitted from the plurality of light source units. The plurality of light source units include a light source configured to emit the exciting light in a direction inclined from a reference emission direction. The adjustment configuration is formed of the plurality of light source units.

In the first feature, the light source apparatus comprises: an optical profile control element (optical profile control element 300) arranged between the light source unit and the light emitting body on a travelling path of the exciting light emitted from the light source unit. The optical profile control element includes a refractive optical element which has a surface shape and separates one intensity center into a plurality of intensity centers. The adjustment configuration is formed of the optical profile control element.

A projection display apparatus according to a second feature comprises: a light source apparatus according to the first feature; an imager that modulates light emitted from the light source apparatus; and a projection unit that projects light emitted from the imager.

### BRIEF DESCRIPTION OF THE DRAWINGS

FIG. 1 is a diagram illustrating a projection display apparatus 100 according to a first embodiment.

FIG. 2 is a diagram illustrating a color wheel 20 according to the first embodiment.

FIG. 3 is a diagram illustrating a light source unit 10B according to the first embodiment.

FIG. 4 is a diagram illustrating the light source unit 10B according to the first embodiment.

FIG. 5 is a diagram illustrating the light source unit 10B according to the first embodiment.

FIG. 6 is a diagram for explaining an adjustment configuration according to the first embodiment.

FIG. 7 is a diagram for explaining the adjustment configuration according to the first embodiment.

FIG. 8 is a diagram for explaining an intensity distribution of exciting light according to the first embodiment.

FIG. 9 is a diagram for explaining the intensity distribution of the exciting light according to the first embodiment.

FIG. 10 is a diagram illustrating a projection display apparatus 100 according to a first modification.

FIG. 11 is a diagram illustrating an optical profile control element 300 according to a second modification.

FIG. 12 is a diagram for explaining an intensity distribution of exciting light according to the second modification.

### DETAILED DESCRIPTION OF THE EMBODIMENTS

Hereinafter, a projection display apparatus according to embodiments of the present invention will be described with reference to the drawings. It is noted that in the following description of the drawings, identical or similar numerals are assigned to identical or similar parts.

### Overview of First Embodiment

A light source apparatus according to a first feature includes a light source unit that emits exciting light, a light emitting body that emits reference image light in response to the exciting light, and a light collecting member that collects the exciting light on the light emitting body. The light source apparatus comprises: an adjustment configuration that adjusts an intensity distribution of the exciting light so that intensity centers of the exciting light are provided on the light emitting body as a plurality of points.

In the embodiment, the adjustment configuration adjusts the intensity distribution of exciting light so that intensity centers of the exciting light are provided on a light emitting body as a plurality of points. Consequently, on the light emitting body, the exciting light is dispersed to be collected at the plurality of points, resulting in the improvement of the light emission efficiency and reliability of the light emitting body.

In addition, the exciting light primarily is blue component light. Reference image light is light that constitutes an image, and for example, includes red component light, green component light, or blue component light.

### First Embodiment

### (Projection Display Apparatus)

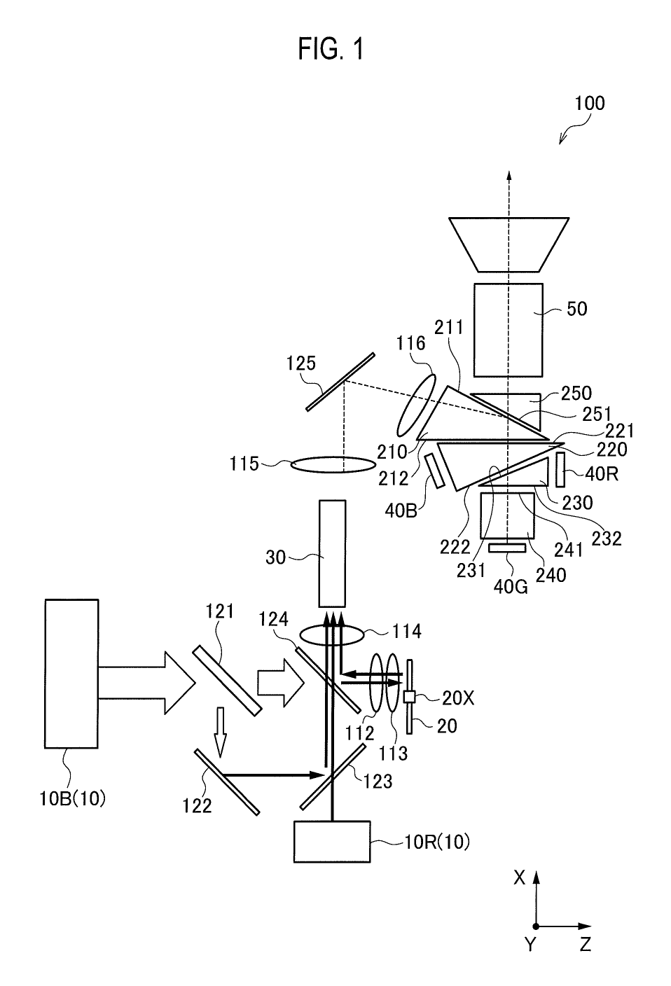

Hereinafter, a projection display apparatus according to a first embodiment is explained. FIG. 1 is a diagram illustrating a projection display apparatus 100 according to a first embodiment. In addition, in the first embodiment, a description will be provided for the case of using red component light R, green component light G, and blue component light B as reference image light.

As illustrated in FIG. 1, firstly, the projection display apparatus 100 includes a light source unit 10, a color wheel 20, a rod integrator 30, a DMD 40, and a projection unit 50.

The light source unit 10, for example, includes a plurality of solid light sources such as LDs (Laser Diodes) or LEDs (Light Emitting Diodes). In the first embodiment, a light source unit 10B and a light source unit 10R are provided as the light source unit 10.

The light source unit 10B emits the blue component light B as exciting light and reference image light. The light source unit 10B, for example, includes a light emitting element such as LD (Laser Diode) or LED (Light Emitting Diode).

The light source unit 10R emits the red component light R as the reference image light. The light source unit 10R, for example, includes a light emitting element such as LD (Laser Diode) or LED (Light Emitting Diode).

The color wheel 20 is configured to rotate about a rotating shaft 20× that extends along an optical axis direction of the exciting light (the blue component light B). The color wheel 20 is an example of a reflective rotating body that reflects the exciting light and the reference image light.

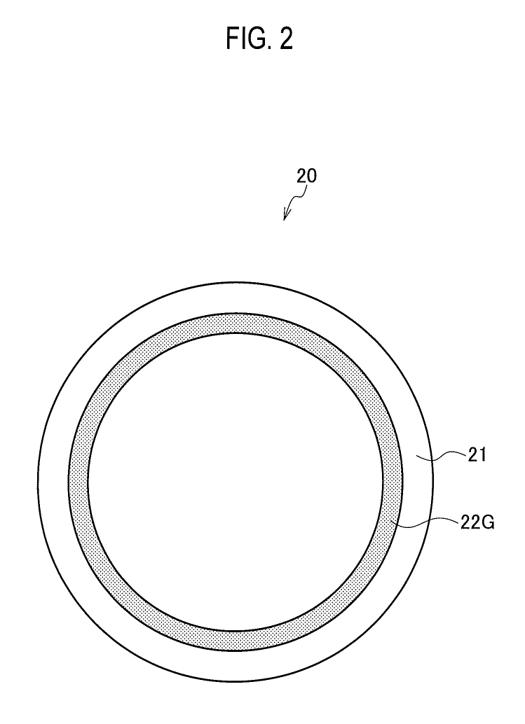

Specifically, as illustrated in FIG. 2, the color wheel 20 includes a rotating surface 21 and a green region 22G. The rotating surface 21 is covered by a reflective film. The green region 22G has a light emitting body G configured to emit the green component light G in response to the exciting light (the blue component light B) emitted from the light source unit 10B. The light emitting body G is a fluorescent substance or a phosphorescent body.

The rod integrator 30 is a solid rod including a transparent member such as glass. The rod integrator 30 uniformizes the light emitted from the light source unit 10. In addition, the rod integrator 30 may be a hollow rod in which an inner wall thereof includes a mirror surface.

The DMD 40 modulates the light emitted from the light source unit 10. Specifically, the DMD 40 includes a plurality of micromirrors, wherein the plurality of micromirrors are movable. Each micromirror is basically equivalent to one pixel. The DMD 40 switches whether to reflect light toward the projection unit 50 by changing an angle of each micromirror.

In the first embodiment, as the DMD 40, a DMD 40R, a DMD 40G, and a DMD 40B are provided. The DMD 40R modulates the red component light R on the basis of a red image signal R. The DMD 40G modulates the green component light G on the basis of a green image signal G. The DMD 40B modulates the blue component light B on the basis of a blue image signal B.

The projection unit 50 projects the image light modulated by the DMD 40 on the projection surface.

Secondly, the projection display apparatus 100 has desired lens group and mirror group. As the lens group, a lens 112 to a lens 116 are provided, and as the mirror group, a mirror 121 to a mirror 125 are provided.

The lens 112 and the lens 113 are condenser lenses that collect the blue component light B (the exciting light) on a light emitting surface of the light emitting body G (the light emitting body). The lens 114 is a light collection lens configured to collect the light beams emitted from the light source unit 10B and the light source unit 10R on a light incident surface of the rod integrator 30. The lens 115 and the lens 116 are relay lenses configured to substantially focus the light emitted from the rod integrator 30 onto each DMD 40.

In the first embodiment, the lens 112 and the lens 113 constitute a light collecting member configured to collect the blue component light B (the exciting light) emitted from the light source unit 10B on the light emitting body G (the light emitting body). Furthermore, the lens 112, the lens 113, and the lens 114 constitute a relay optical system configured to collect light beams on the light incident surface of the rod integrator 30.

The mirror 121 is a beam splitter configured to transmit a part of the blue component light B emitted from the light source unit 10B, and reflect a remaining part of the blue component light B.

The mirror 122 is a reflection mirror configured to reflect the blue component light B reflected by the mirror 121. The mirror 123 is a dichroic mirror configured to transmit the red component light R and reflect the blue component light B. The mirror 124 is a dichroic mirror configured to transmit the blue component light B and the red component light R and reflect the green component light G. The mirror 125 is a reflection mirror configured to reflect each color component light.

Thirdly, the projection display apparatus 100 has a desired prism group. As the prism group, a prism 210, a prism 220, a prism 230, a prism 240, and a prism 250 are provided.

The prism 210 includes a light transmitting member and has a surface 211 and a surface 212. Since an air gap is provided between the prism 210 (the surface 211) and the prism 250 (a surface 251) and an angle (an incident angle), at which light incident into the prism 210 is incident into the surface 211, is larger than a total reflection angle, the light incident into the prism 210 is reflected by the surface 211. Meanwhile, since an air gap is provided between the prism 210 (the surface 212) and the prism 220 (a surface 221), but an angle (an incident angle), at which the light reflected by the surface 211 is incident into the surface 212, is smaller than the total reflection angle, the light reflected by the surface 211 passes through the surface 212.

The prism 220 includes a light transmitting member and has the surface 221 and a surface 222. Since an air gap is provided between the prism 210 (the surface 212) and the prism 220 (the surface 221) and an angle (an incident angle), at which blue component light B initially reflected by the surface 222 and blue component light B emitted from the DMD 40B are incident into the surface 211, is larger than the total reflection angle, the blue component light B initially reflected by the surface 222 and the blue component light B emitted from the DMD 40B are reflected by the surface 221. Meanwhile, since an angle (an incident angle), at which the blue component light B reflected by the surface 221 and then reflected by the surface 222 at the second time is incident into the surface 211, is smaller than the total reflection angle, the blue component light B reflected by the surface 221 and then reflected by the surface 222 at the second time passes through the surface 221.

The surface 222 is a dichroic mirror surface that transmits the red component light R and the green component light G, and reflects the blue component light B. Accordingly, among the light beams reflected by the surface 211, the red component light R and the green component light G pass through the surface 222, and the blue component light B is reflected by the surface 222. The blue component light B reflected by the surface 221 is reflected by the surface 222.

The prism 230 includes a light transmitting member and has a surface 231 and a surface 232. Since an air gap is provided between the prism 220 (the surface 222) and the prism 230 (the surface 231) and an angle (an incident angle), at which red component light R reflected by the surface 232 after passing through the surface 231 and red component light R emitted from the DMD 40R are incident into the surface 231 again, is larger than the total reflection angle, the red component light R reflected by the surface 232 after passing through the surface 231 and the red component light R emitted from the DMD 40R are reflected by the surface 231. Meanwhile, since an angle (an incident angle), at which the red component light R reflected by the surface 232 after being emitted from the DMD 40R and reflected by the surface 231 is incident into the surface 231 again, is smaller than the total reflection angle, the red component light R reflected by the surface 232 after being emitted from the DMD 40R and reflected by the surface 231 passes through the surface 231.

The surface 232 is a dichroic mirror surface that transmits the green component light G, and reflects the red component light R. Accordingly, among the light beams having passed through the surface 231, the green component light G passes through the surface 232, and the red component light R is reflected by the surface 232. The red component light R reflected by the surface 231 is reflected by the surface 232. The green component light G emitted from the DMD 40G passes through the surface 232.

The prism 240 includes a light transmitting member and has a surface 241. The surface 241 is configured to transmit the green component light G. In addition, the green component light G incident into the DMD 40G and the green component light G emitted from the DMD 40G pass through the surface 241.

The prism 250 includes a light transmitting member and has a surface 251.

In other words, the blue component light B is reflected by the surface 211 (1), is reflected by the surface 222 (2), is reflected by the surface 221 (3), is reflected by the DMD 40B (4), is reflected by the surface 221 (5), is reflected by the surface 222 (6), and passes through the surface 221 and the surface 251 (7). In this way, the blue component light B is modulated by the DMD 40B and is guided to the projection unit 50.

The red component light R is reflected by the surface 211 (1), is reflected by the surface 232 after passing through the surface 212, the surface 221, the surface 222, and the surface 231 (2), is reflected by the surface 231 (3), is reflected by the DMD 40R (4), is reflected by the surface 231 (5), is reflected by the surface 232 (6), and passes through the surface 231, the surface 232, the surface 221, the surface 212, the surface 211, and the surface 251 (7). In this way, the red component light R is modulated by the DMD 40R and is guided to the projection unit 50.

The green component light G is reflected by the surface 211 (1), is reflected by the DMD 40G after passing through the surface 212, the surface 221, the surface 222, the surface 231, the surface 232, and the surface 241 (2), and passes through the surface 241, the surface 232, the surface 231, the surface 222, the surface 221, the surface 212, the surface 211, and the surface 251. In this way, the green component light G is modulated by the DMD 40G and is guided to the projection unit 50.

### (Light Source Unit)

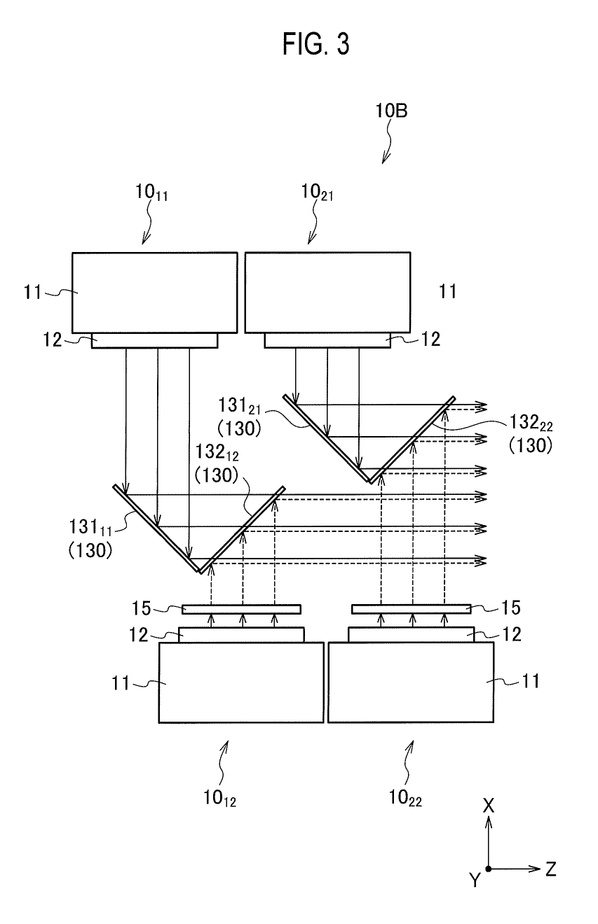

Hereinafter, a light source unit according to the first embodiment is explained. FIG. 3 to FIG. 5 are diagrams illustrating the light source unit 10B according to the first embodiment.

As illustrated in FIG. 3, the light source unit 10B includes a plurality of light source units (a light source unit 10₁₁, a light source unit 10₁₂, a light source unit 10₂₁, and a light source unit 10₂₂), and a plurality of mirrors (a reflection mirror 131₁₁, a polarization mirror 132₁₂, a reflection mirror 131₂₁, and a polarization mirror 132₂₂).

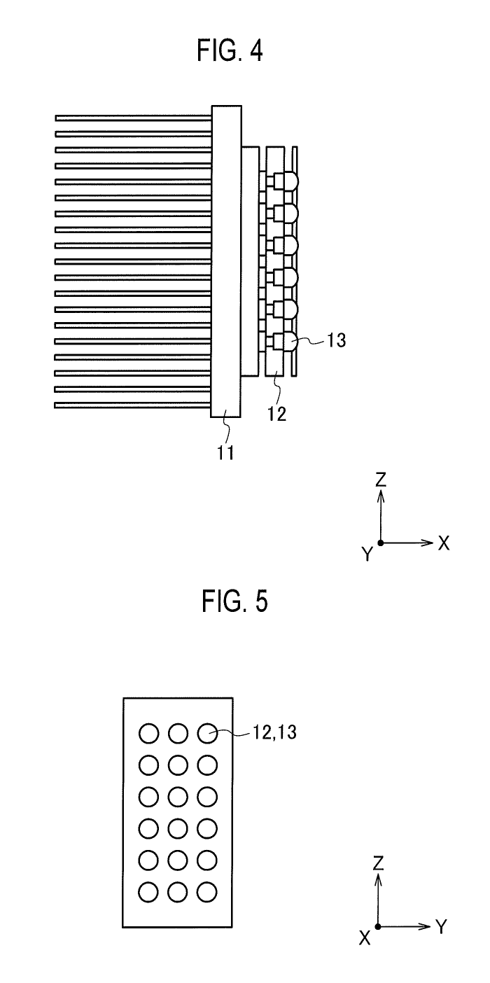

The light source unit 10₁₁, the light source unit 10₁₂, the light source unit 10₂₁, and the light source unit 10₂₂ have a heat sink 11, a plurality of light emitting elements 12, and a plurality of lenses 13, respectively, as illustrated in FIG. 4 and FIG. 5.

The heat sink 11 is a metal plate and the like for radiating heat generated in the plurality of light emitting elements 12. Each light emitting element 12 includes LD, LED and the like for emitting the blue component light B. Each lens 13 collects the blue component light B emitted from the each light emitting element 12.

For example, in the first embodiment, three light emitting elements 12 are arranged in a row in the Y-axis direction and six light emitting elements 12 are arranged in a row in the Z-axis direction.

Returning to FIG. 3, a 1/2λ plate 15 is provided at the light emitting sides of the light source unit 10₁₂ and the light source unit 10₂₂. The ½λ plate 15 is a phase difference plate that rotates a polarizing direction of the blue component light B, which is emitted from the light source unit 10₁₂ and the light source unit 10₂₂, by 90° C.

For example, a case, in which a polarized light of the blue component light B emitted from the light source unit 10₁₂ and the light source unit 10₂₂ is a P-polarized light with respect to the polarization mirror 132₁₂ and the polarization mirror 132₂₂ is considered. In such a case, the polarized light of the blue component light B transmitting the ½λ plate 15 is converted to an S-polarized light.

The reflection mirror 131₁₁ is a mirror that reflects the blue component light B, which is emitted from the light source unit 10₁₁ along the X-axis direction, in the Z-axis direction. Similarly, the reflection mirror 131₂₁ is a mirror that reflects the blue component light B, which is emitted from the light source unit 10₂₁ along the X-axis direction, in the Z-axis direction.

The polarization mirror 132₁₂ and the polarization mirror 132₂₂ are mirrors that transmit a first polarized light component (a P-polarized light component) and reflect a second polarized light component (an S-polarized light component). That is, the polarization mirror 132₁₂ reflects the blue component light B, which is emitted from the light source unit 10₁₂ along the X-axis direction, in the Z-axis direction. Similarly, the polarization mirror 132₂₂ reflects the blue component light B, which is emitted from the light source unit 10₂₂ along the X-axis direction, in the Z-axis direction. In addition, it should be noted that the polarization mirror 132₁₂ transmits the blue component light B reflected by the reflection mirror 131₁₁. Similarly, it should be noted that the polarization mirror 132₂₂ transmits the blue component light B reflected by the reflection mirror 131₂₁.

As described above, the reflection mirror 131₁₁, the polarization mirror 132₁₂, the reflection mirror 131₂₁, and the polarization mirror 132₂₂ constitute a combining unit 130 configured to combine light beams emitted from the light source unit 10₁₁, the light source unit 10₁₂, the light source unit 10₂₁, and the light source unit 10₂₂.

In general, the blue component light B emitted from the light source unit 10₁₁, the light source unit 10₁₂, the light source unit 10₂₁, and the light source unit 10₂₂ are aligned along the Z-axis direction. Accordingly, a reference emission direction, in which the blue component light B are to be emitted from the light source unit 10₁₁, the light source unit 10₁₂, the light source unit 10₂₁, and the light source unit 10₂₂, is the X-axis direction. Furthermore, a reference angle, at which the reflection mirror 131₁₁, the polarization mirror 132₁₂, the reflection mirror 131₂₁, and the polarization mirror 132₂₂ are to be arranged, is 45° with respect to the X-axis direction and the Z-axis direction.

In the first embodiment, as described below, it should be noted that a member constituting the light source unit 10B may be not arranged along the reference emission direction or at the reference angle.

In the first embodiment, the projection display apparatus 100 has an adjustment configuration configured to adjust the intensity distribution of the exciting light so that intensity centers of the exciting light are provided on the light emitting body as a plurality of points.

In the first embodiment, the adjustment configuration is formed of a member constituting the light source unit 10B.

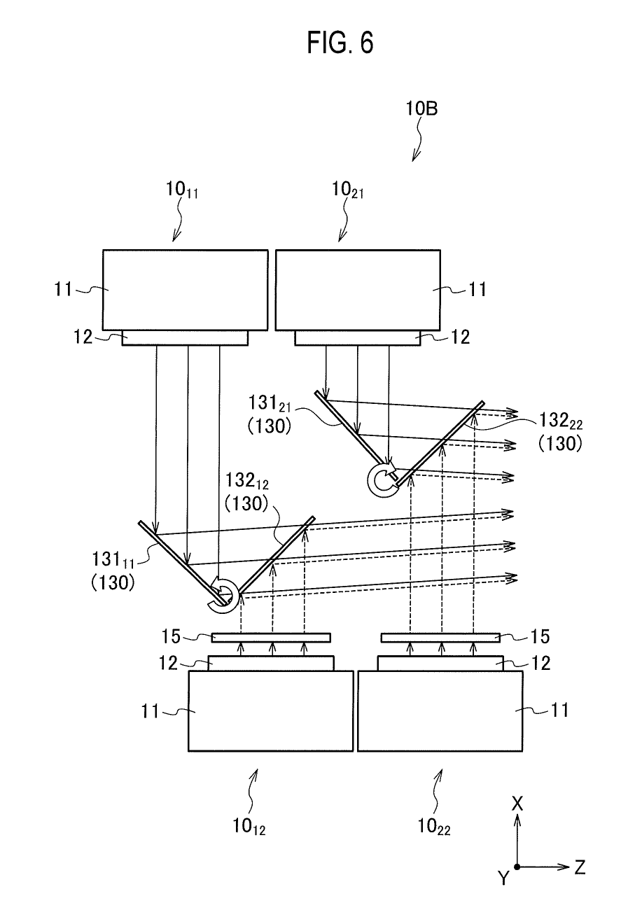

Specifically, as illustrated in FIG. 6, the reflection mirror 131₁₁ and the polarization mirror 132₁₂ are arranged to be inclined with respect to the reference angle. For example, the reflection mirror 131₁₁ and the polarization mirror 132₁₂ are arranged at an angle turned right about a turning axis along the Y-axis direction with respect to the reference angle.

Similarly, the reflection mirror 131₂₁ and the polarization mirror 132₂₂ are arranged to be inclined with respect to the reference angle. For example, the reflection mirror 131₂₁ and the polarization mirror 132₂₂ are arranged at an angle turned left about the turning axis along the Y-axis direction with respect to the reference angle.

With such a configuration, travel directions of the blue component light beams B reflected by the reflection mirror 131₁₁ and the polarization mirror 132₁₂ are different from travel directions of the blue component light beams B reflected by the reflection mirror 131₂₁ and the polarization mirror 132₂₂. That is, the adjustment configuration is formed of the reflection mirror 131₁₁, the polarization mirror 132₁₂, the reflection mirror 131₂₁, and the polarization mirror 132₂₂.

In the case illustrated in FIG. 6, it should be noted that the light source unit 10₁₁, the light source unit 10₁₂, the light source unit 10₂₁, and the light source unit 10₂₂ emit the blue component light B (the exciting light) in the reference emission direction.

Furthermore, either one of a mirror group of the reflection mirror 131₁₁ and the polarization mirror 132₁₂ or a mirror group of the reflection mirror 131₂₁ and the polarization mirror 132₂₂, may be arranged at the reference angle.

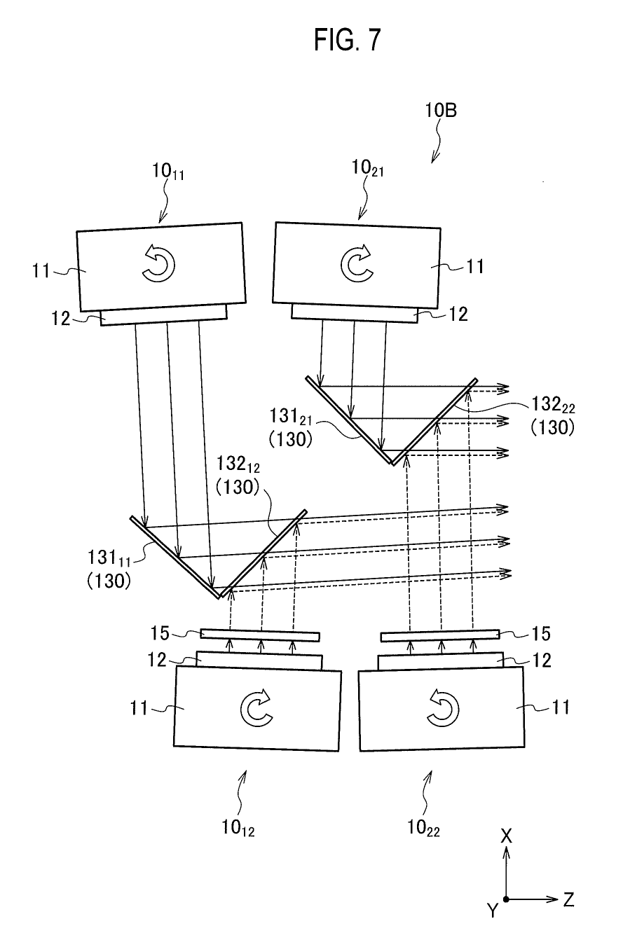

Alternatively, as illustrated in FIG. 7, the light source unit 10₁₁ and the light source unit 10₁₂ emit the blue component light B (the exciting light) in a direction inclined from the reference emission direction. However, it should be noted that the light source unit 10₁₁ and the light source unit 10₁₂ are arranged such that the travel directions of the blue component light beams B reflected by the reflection mirror 131₁₁ and the polarization mirror 132₁₂ coincide with each other. For example, the light source unit 10₁₁ is arranged at an angle turned left about the turning axis along the Y-axis direction, and the light source unit 10₁₂ is arranged at an angle turned right about the turning axis along the Y-axis direction.

Similarly, the light source unit 10₂₁ and the light source unit 10₂₂ emit the blue component light B (the exciting light) in a direction inclined from the reference emission direction. However, it should be noted that the light source unit 10₂₁ and the light source unit 10₂₂ are arranged such that the travel directions of the blue component light beams B reflected by the reflection mirror 131₂₁ and the polarization mirror 132₂₂ coincide with each other. For example, the light source unit 10₂₁ is arranged at an angle turned right about the turning axis along the Y-axis direction, and the light source unit 10₂₂ is arranged at an angle turned left about the turning axis along the Y-axis direction.

With such a configuration, travel directions of the blue component light beams B reflected by the reflection mirror 131₁₁ and the polarization mirror 132₁₂ are different from travel directions of the blue component light beams B reflected by the reflection mirror 131₂₁ and the polarization mirror 132₂₂. That is, the adjustment configuration is formed of the light source unit 10₁₁, the light source unit 10₁₂, the light source unit 10₂₁, and the light source unit 10₂₂.

In the case illustrated in FIG. 7, it should be noted that the reflection mirror 131₁₁, the polarization mirror 132₁₂, the reflection mirror 131₂₁, and the polarization mirror 132₂₂ are arranged at the reference angle.

Furthermore, an emission direction of either one of a unit group of the light source unit 10₁₁ and the light source unit 10₁₂ or a unit group of the light source unit 10₂₁ and the light source unit 10₂₂ may be inclined from the reference emission direction.

### (Intensity Distribution of Exciting Light)

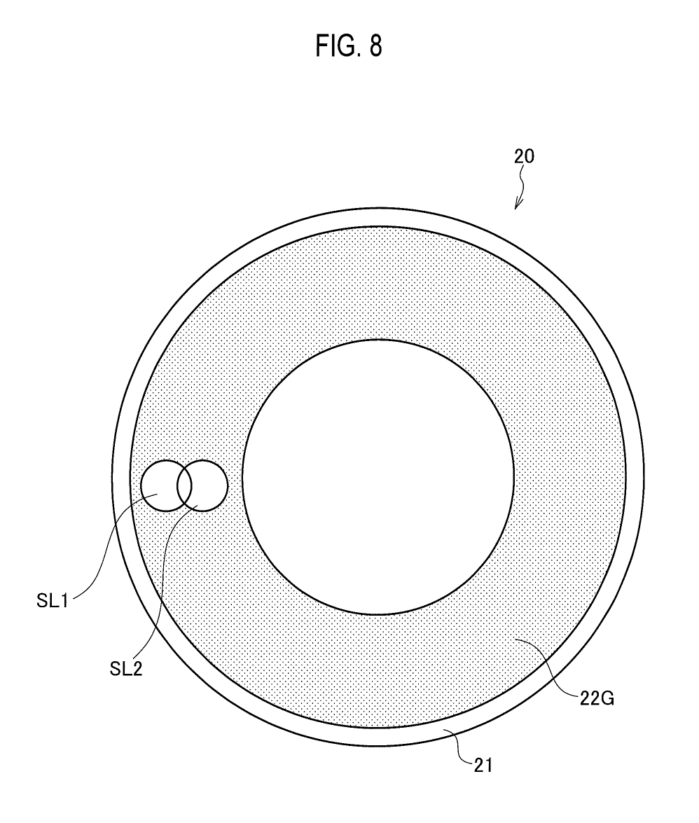

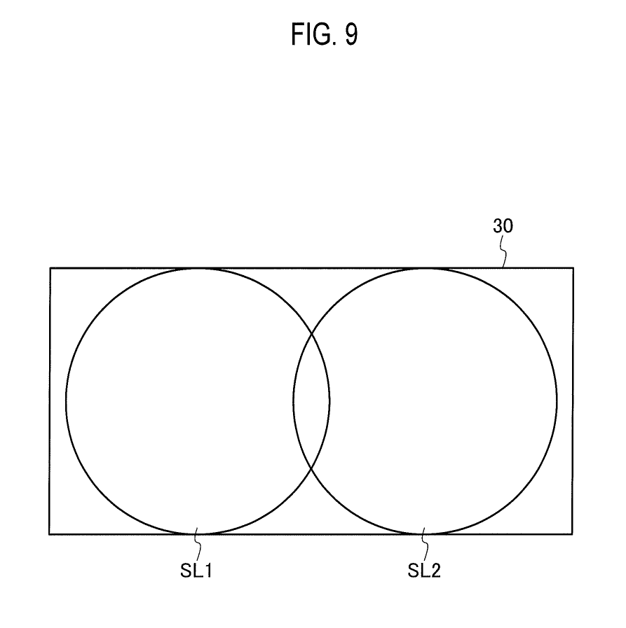

Hereinafter, the intensity distribution of the exciting light according to the first embodiment is explained. FIG. 8 and FIG. 9 are diagrams for explaining the intensity distribution of the exciting light according to the first embodiment.

According to the aforementioned adjustment configuration, the intensity centers of the blue component light B (the exciting light) are provided on the green region 22G (the light emitting body G) as a plurality of points. Specifically, as illustrated in FIG. 8, spot light beams SL1 of the blue component light beams B emitted from the light source unit 10₁₁ and the light source unit 10₁₂ are collected at points different from those of spot light beams SL2 of the blue component light beams B emitted from the light source unit 10₂₁ and the light source unit 10₂₂. In addition, the spot light beams SL1 and the spot light beams SL2 have a circular shape expressed by a Gaussian function.

Furthermore, it is preferable that the intensity distribution of the blue component light B (the exciting light) corresponds to the shape of a light incident surface of the rod integrator 30 as illustrated in FIG. 9. In other words, it is preferable that the aforementioned adjustment configuration adjusts the intensity distribution of the blue component light B (the exciting light) according to the shape of the light incident surface of the rod integrator 30.

Specifically, the reflection mirror 131₁₁, the polarization mirror 132₁₂, the reflection mirror 131₂₁, and the polarization mirror 132₂₂ are arranged such that an aspect ratio based on the intensity distribution of the blue component light B (the exciting light) coincides with an aspect ratio of the light incident surface of the rod integrator 30.

Alternatively, the blue component light B (the exciting light) is emitted from the light source unit 10₁₁, the light source unit 10₁₂, the light source unit 10₂₁, and the light source unit 10₂₂ such that the aspect ratio based on the intensity distribution of the blue component light B (the exciting light) coincides with the aspect ratio of the light incident surface of the rod integrator 30.

### (Operation and Effect)

In the embodiment, the adjustment configuration adjusts the intensity distribution of the blue component light B such that the intensity centers of the blue component light B (the exciting light) are provided on the green region 22G (the light emitting body G) as a plurality of points. Consequently, the blue component light B is dispersed and is collected at the plurality of points on the green region 22G (the light emitting body G), resulting in the improvement of the light emission efficiency and reliability of the light emitting body G.

### [First Modification]

Hereafter, a first modification of the first embodiment is explained. Mainly, the differences from the first embodiment are explained below.

In the first embodiment, the adjustment configuration is formed of members constituting the light source unit 10B. On the other hand, in the first modification, a refractive optical element (an optical profile control element) having a surface shape is provided to separate one intensity center into a plurality of intensity centers.

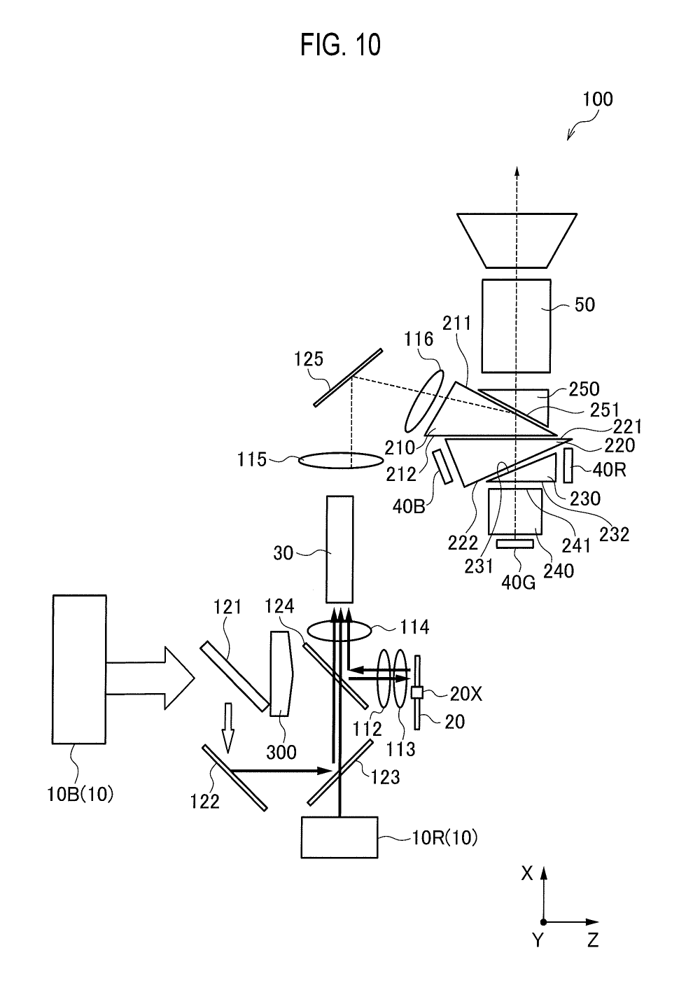

Specifically, as illustrated in FIG. 10, a projection display apparatus 100 includes an optical profile control element 300 in addition to the configuration illustrated in FIG. 1.

The optical profile control element 300 is arranged between the light source unit 10B and the color wheel 20 (the light emitting body G) on the blue component light B (the exciting light) emitted from the light source unit 10B. The optical profile control element 300 is a refractive optical element which has a surface shape and separates one intensity center into a plurality of intensity centers. In the first modification, the optical profile control element 300 separates the blue component light B (the exciting light) emitted from the light source unit 10B into two spot light beams.

In addition, in the first modification, the members constituting the light source unit 10B are arranged along the reference emission direction and at the reference angle.

In the first modification, the optical profile control element 300 is inserted, so that it is possible to emit two types of angle configurations from the optical profile control element 300. Accordingly, similarly to FIG. 8, two types of spot light beams (the spot light SL1 and the spot light SL2) are collected at different points on the green region 22G (the light emitting body G). In this way, similarly to FIG. 9, the two types of spot light beams are collected such that the aspect ratio based on the intensity distribution of the blue component light B (the exciting light) coincides with the aspect ratio of the light incident surface of the rod integrator 30.

### [Second Modification]

Hereafter, a second modification of the first embodiment is explained. Mainly, the differences from the first modification are explained below.

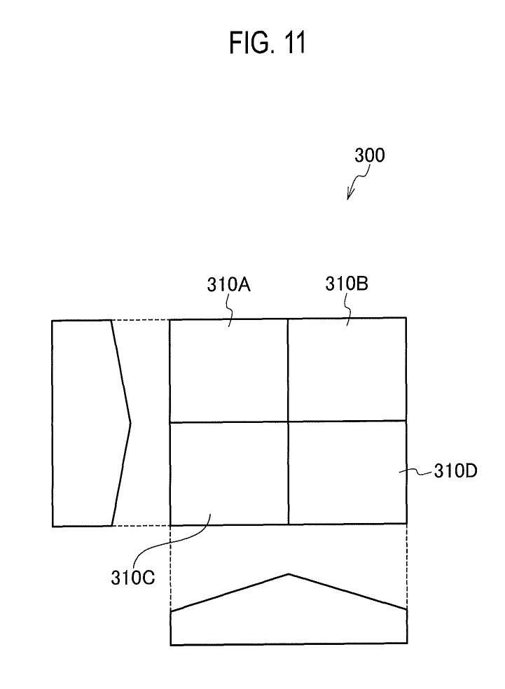

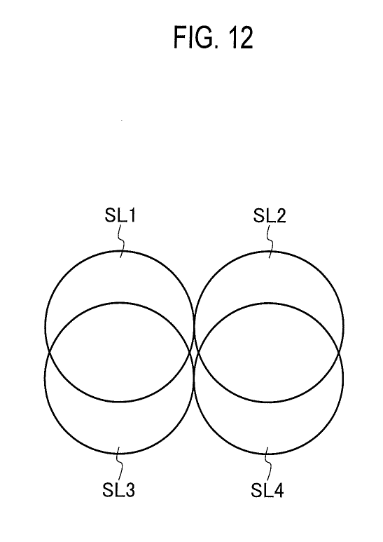

In the second modification, the optical profile control element 300 has four areas (an area 310A to an area 310D) as illustrated in FIG. 11. In each area, one spot light is separated from the blue component light B (the exciting light) emitted from the light source unit 10B. That is, in the second modification, as illustrated in FIG. 12, the blue component light B (the exciting light) emitted from the light source unit 10B is separated into four spot light beams (spot light SL1 to spot light SL4) by the optical profile control element 300.

### Other Embodiments

The present invention is explained through the above embodiment, but it must not be understood that this invention is limited by the statements and the drawings constituting a part of this disclosure. From this disclosure, various alternative embodiments, examples, and operational technologies will become apparent to those skilled in the art.

In the embodiment, three DMDs are exemplified as the imager. However, the present embodiment is not limited thereto. For example, the imager may be one DMD. Alternatively, the imager may be one liquid crystal panel or three liquid crystal panels (a red liquid crystal panel, a green liquid crystal panel, and a blue liquid crystal panel). The liquid crystal panel may be a transmissive liquid crystal panel or a reflective liquid crystal panel.

In the embodiment, the light emitting body G, which emits the green component light G in response to the exciting light, is exemplified as a light emitting body. However, the light emitting body may be a light emitting body configured to emit red component light R or blue component light B in response to the exciting light.

In the embodiment, the blue component light B is exemplified as the exciting light. However, the exciting light may be an ultraviolet component light.

Particularly not mentioned in the embodiment, it is sufficient if the light source apparatus includes at least the light source unit 10B. Alternatively, it is sufficient if the light source apparatus includes at least the light source unit 10B and the optical profile control element 300.

What is claimed is:

1. A light source apparatus, which includes a light source unit that emits exciting light, a light emitting body that emits reference image light in response to the exciting light, and a light collecting member that collects the exciting light on the light emitting body, comprising:
an adjustment configuration that adjusts an intensity distribution of the exciting light so that intensity centers of the exciting light are provided on the light emitting body as a plurality of points.

2. The light source apparatus according to claim 1, comprising:
a rod integrator configured to uniformize the reference image light emitted from the light emitting body, wherein
the adjustment configuration adjusts the intensity distribution of the exciting light according to a shape of a light incident surface of the rod integrator.

3. The light source apparatus according to claim 1, wherein
the light source unit includes a plurality of light source units and a plurality of mirrors that reflects the exciting light emitted from the plurality of light source units,
the plurality of mirrors include a mirror arranged to be inclined from a reference angle, and
the adjustment configuration is formed of the plurality of mirrors.

4. The light source apparatus according to claim 1, wherein
the light source unit includes a plurality of light source units and a plurality of mirrors that reflects the exciting light emitted from the plurality of light source units,
the plurality of light source units include a light source configured to emit the exciting light in a direction inclined from a reference emission direction, and
the adjustment configuration is formed of the plurality of light source units.

5. The light source apparatus according to claim 1, comprising:
an optical profile control element arranged between the light source unit and the light emitting body on a travelling path of the exciting light emitted from the light source unit, wherein
the optical profile control element includes a refractive optical element which has a surface shape and separates one intensity center into a plurality of intensity centers, and
the adjustment configuration is formed of the optical profile control element.

6. A projection display apparatus, comprising:
a light source apparatus according to claim 1;
an imager that modulates light emitted from the light source apparatus; and
a projection unit that projects light emitted from the imager.
